(19) United States
(12) Patent Application Publication
(10) Pub. No.: US 2019/0345720 A1
(43) Pub. Date: Nov. 14, 2019

(54) ROOFING REMOVAL TOOL

(71) Applicant: Jason McKinney, Ridgefield, WA (US)

(72) Inventor: Jason McKinney, Ridgefield, WA (US)

(21) Appl. No.: 15/977,230

(22) Filed: May 11, 2018

(51) Int. Cl. E04D 15/00; B66F 15/00

(52) U.S. Cl. CPC E04D 15/003; B66F 15/00

(57) ABSTRACT

Example aspects of a roofing removal tool and a method for constructing a roofing removal tool are disclosed. The roofing removal tool can comprise a shaft defining an upper section, a lower section, and an intermediate section therebetween, a base positioned at the lower section, a first handle extending from the upper section in a first direction, and a second handle extending from one of the upper section and the intermediate section in a second direction that is different from the first direction.

### TECHNICAL FIELD

This disclosure relates to roofing removal tools. More specifically, this disclosure relates to a roofing removal tool comprising a pair of handles.

### BACKGROUND

Roofing material, such as shingles, can be attached to a roof of a structure (e.g., a building) to cover and protect the roof. Roofing material can become worn or damaged over time and often must be removed and replaced with new roofing material. Shingles and other roofing materials are typically nailed down to roofs, making removal difficult. Roofing removal tools can aid in the removal of the roofing material from the roof.

Commonly, roofing removal tools comprise a hand grip, a base, and a shaft extending between the hand grip and the base. Often the base is oriented at an angle with respect to the shaft. The base can be wedged underneath the roofing material on a roof. A user can grasp the hand grip with a first hand and push down on the hand grip, which can push the base upward against the roofing material, breaking the roofing material away from the roof.

Users often bend forward to grasp the shaft with a second hand to obtain improved control over the roofing removal tool during use. Further, users often bend forward as they push down on the hand grip. Such bending motions can cause stress in the user's lower back and other areas of the body, resulting in pain and/or injury.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts off the disclosure as an introduction to the following complete and extensive detailed description.

Disclosed is a roofing removal tool comprising a shaft defining an upper section, a lower section, and an intermediate section therebetween, a base positioned at the lower section, a first handle extending from the upper section in a first direction, and a second handle extending from one of the upper section and the intermediate section in a second direction that is different from the first direction.

Also disclosed is a roofing removal tool comprising a shaft defining a first end and a second end, an arm rest coupled to the shaft a first location along the shaft proximate to the first end, a first handle extending from the shaft at a second location along the shaft, a second handle extending from the shaft at a third location along the shaft, wherein the second location is oriented between the first location and the third location, and a base coupled to the shaft at a fourth location along the shaft proximate to the second end.

Also disclosed is a method for constructing a roofing removal tool comprising the steps of positioning a base at a lower end of a shaft, the base comprising a plurality of teeth, positioning an arm rest at an upper end of the shaft, positioning a first handle along the shaft at a first distance from the arm rest, and positioning a second handle along the shaft at a second distance from the arm rest that is greater than the first distance.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a roofing removal tool comprising a shaft, a base, and a pair of handles, in accordance with one example aspect of the present disclosure.

FIG. 2 is a perspective view of the base of FIG. 1 in engagement with the shaft of FIG. 1.

FIG. 3 is a perspective view of the pair of handles of FIG. 1 in engagement with the shaft of FIG. 1.

FIG. 4 is a side view of the roofing removal tool of FIG. 1 in use, in accordance with an example aspect of the present disclosure.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed in the present application is a roofing removal tool and associated methods, systems, devices, and various apparatus. Example aspects of the roofing removal tool can comprise a base, a shaft extending from the base, and a pair of handles extending from the shaft. It would be understood by one of skill in the art that the disclosed roofing removal tool is described in but a few exemplary aspects among many. No particular terminology or description should be considered limiting on the disclosure or the scope of any claims issuing therefrom.

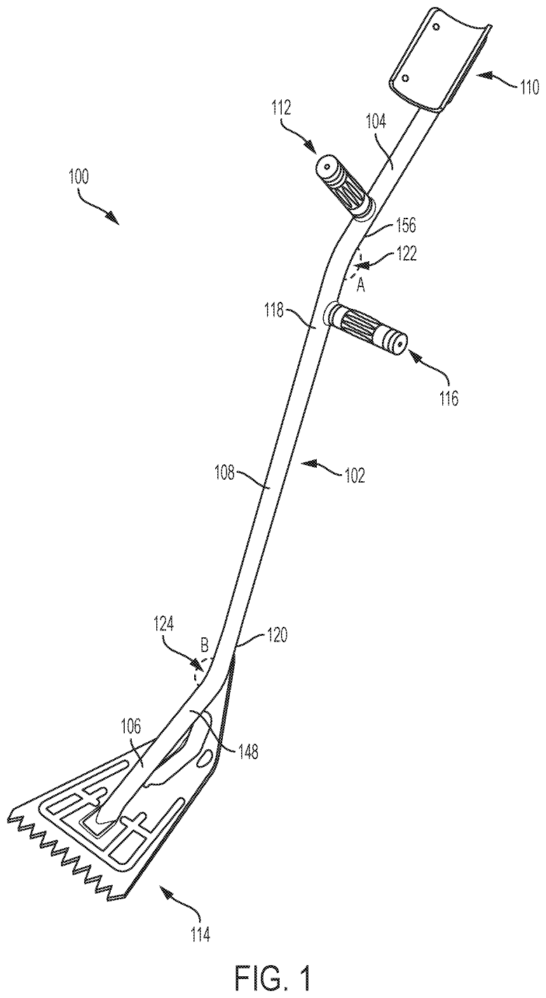

FIG. 1 illustrates a first aspect of a roofing removal tool 100 according to the present disclosure. As shown, the roofing removal tool 100 can comprise a shaft 102 defining an upper section 104, a lower section 106, and an intermediate section 108 extending between the upper section 104 and the lower section 106. Example aspects of the upper section 104 of the shaft 102 can be positioned above the lower section 106 of the shaft 102, relative to the orientation shown. Further, the shaft 102 can define a generally cylindrical shape defining a generally circular cross-section. In other example aspects, the shaft 102 can define a cylindrical shape defining an oval cross-section. In still other example aspects, the shaft 102 can define another cross-sectional shape, such as square, rectangular, triangular, etc. The roofing removal tool 100 can further comprise an arm rest 110 and a first handle 112 that can be positioned on the upper section 104 of the shaft 102. The roofing removal tool 100 can further comprise a base 114 that can be positioned on the lower section 106 of the shaft 102. The roofing removal tool 100 can further comprise a second handle 116. Example aspects of the first handle 112 and the second handle 116 are spaced apart along the shaft 102. For example, as shown, the second handle 116 can be positioned on the intermediate section 108 of the shaft 102. In other example aspects, the second handle 116 can be positioned on the upper section 104 of the shaft 102.

As shown, a lower end 156 of the upper section 104 of the shaft 102 can be joined with an upper end 118 of the intermediate section 108 of the shaft 102, and an upper end 148 of the lower section 106 can be joined with a lower end 120 of the intermediate section 108. The upper section 104 of the shaft 102 can be oriented at an angle A with respect to the intermediate section 108 of the shaft 102 to define a first bend 122 in the shaft 102. The lower section 106 of the shaft 102 can be oriented at an angle B with respect the intermediate section 108 of the shaft 102 to define a second bend 124 in the shaft 102. According to example aspects, angle A and angle B can define obtuse angles. The upper section 104, lower section 106, and/or intermediate section 108 of the shaft 102 can be integrally formed with one another, as shown in FIG. 1, such as being formed from a single monolithic extruded metal post and having bends 122,124 formed in the post after or during extrusion. In other aspects, the upper section 104, lower section 106, and/or intermediate section 108 can be formed as separate components and can be coupled together via a fastener, such as, for example, screws, welds, VALCO snap buttons, clips, rivets, snaps, adhesives, or any other suitable fastening device known in the art. Example aspects of the shaft 102 and can be formed from a metal material, such as, for example, extruded steel or aluminum. In other example aspects, the shaft 102 can be formed from another suitable material, or a combination of materials, that are known in the art, including but not limited to plastic, other metals, resin, synthetic materials, and fibers. Optionally, the shaft 102 can be formed as a hollow tube to reduce the weight and materials cost of the roofing removal tool 100. In other aspects, however, the shaft 102 can be solid.

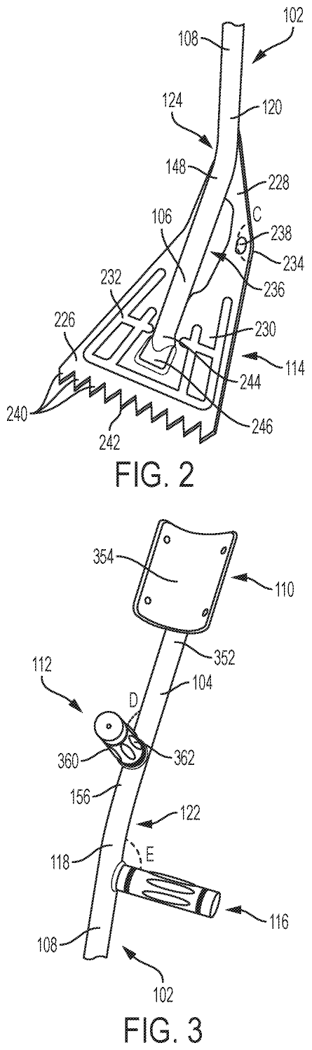

FIG. 2 illustrates the lower section 106 of the shaft 102 extending from the intermediate section 108 of the shaft 102, and further illustrates the base 114 coupled to the lower section 106 of the shaft 102. Example aspects of the base 114 can define a front portion 226, an opposing back portion 228, and an intermediate portion 230 extending therebetween. The base 114 can further define an upper surface 232 and a lower surface (not shown) opposite the upper surface 232. According to example aspects, the back portion 228 of the base 114 can be oriented at an angle C relative to the intermediate portion 230 of the base 114 and can extend upwardly therefrom, relative to the orientation shown. As illustrated in the drawings, a corner 234 can be defined at the junction of the back and intermediate portions 228,230 of the base 114. In example aspects, the angle C can define an obtuse angle, as shown, and in other aspects, the angle C can be approximately 90°. The base 114 can also comprise an opening 236 formed therein. The opening 236 can span from the intermediate portion 230 of the base 114 to the back portion 228 of the base 114 and can extend from the upper surface 232 of the base 114 to the lower surface. Example aspects of the opening 236 can define an oblong shape, as shown. Other example aspects can define another shape, as desired. Example aspects can comprise ribs 238 formed on the upper surface 232 of the base 114 to reinforce the corner 234 formed between the back and intermediate portions 228,230 of the base 114. For example, a pair of ribs 238 can be formed at the corner 234 of the base 114, and each rib 238 can be oriented on an opposite side of the opening 236. Note, only one of the pair of ribs 238 is visible in FIG. 2. Other aspects of the base 114 can comprise more or fewer ribs 238.

Example aspects of the base 114 can taper outwardly from the back portion 228 to the front portion 226, such that a width of the base 114 at the front portion 226 can be greater than a width of the base 114 at the back portion 228. Further, as shown, the front portion 226 of the base 114 and the intermediate portion 230 of the base 114 can be substantially co-planar and can define a generally flat profile. Example aspects of the front portion 226, back portion 228, and/or intermediate portion 230 of the base 114 can be integrally formed with one another, as illustrated in FIG. 2. Other example aspects of the front portion 226, back portion 228, and/or intermediate portion 230 of the base 114 can be formed as separate components. The base 114 can be formed from a metal material, such as a steel or aluminum sheet stamped and bent as desired to form the base 114, and in example aspects, the base 114 can be formed from the same material as the shaft 102. In other example aspects, the base 114 can be formed from a different material than the shaft 102. Further, in other aspects, the base 114 can be formed from another suitable material, or a combination of materials, that are known in the art, including but not limited to plastic, other metals, resin, synthetic materials, and fibers.

Example aspects of the base 114 can further comprise a plurality of teeth 240 extending forwardly therefrom, relative to the orientation shown. As illustrated in FIG. 2, the teeth 240 can extend from the front portion 226 of the base 114 and can be generally coplanar with the front and intermediate portions 226,230 of the base 114. Example aspects of the teeth 240 can be generally triangular in shape, and can be oriented such that a vertex of each tooth 240 can be formed at a distal end 242 of the tooth 240. In other aspects, the teeth 240 can be non-coplanar with the front and intermediate portions 226,230 of the base 114. For example, other aspects of the teeth 240 can curve upwardly at their distal ends 242. Further, according to other example aspects, the teeth 240 can be differently shaped, such as, for example, pentagonally-shaped. The teeth 240 can be integrally formed with the base 114, as shown, and can comprise the same material(s) as the base 114, such as, for example, steel. In some aspects, the teeth 240 can be heat-tempered. In other example aspects, the teeth 240 can be separately formed from the base 114 and can be attached to the base 114 via a fastener, such as welding, and/or can comprise material(s) that are different from the material of the base 114. Other suitable materials can include, but are not limited to, other metals, plastic, resin, synthetic materials, and fibers

According to example aspects of the disclosure, the base 114 can be coupled to the lower section 106 of the shaft 102. As shown in the example aspect of FIG. 2, a lower end 244 of the lower section 106 of the shaft 102 can be coupled to the upper surface 232 of the intermediate portion 230 of the base 114. In other aspects, the lower end 244 of the lower section 106 of the shaft 102 can be coupled to the front portion 226 of the base 114. According to example aspects, the base 114 and the shaft 102 can be formed separately, and the lower section 106 of the shaft 102 can be coupled to the intermediate section 130 of the base 114 via a fastener, such as welding 246. In other example aspects, the lower section 106 of the shaft 102 can be coupled to the intermediate portion 230 of the base 114 via another fastener, such as, for example, screws, adhesives, rivets, VALCO snap buttons, or any other fastening device known in the art. In still other aspects, the shaft 102 can be integrally formed with the base 114.

According to some example aspects, the base 114 can also be coupled to the shaft 102 at the back portion 228 of the base 114. In the depicted example aspect of FIG. 2, the back portion 228 of the base 114 can be coupled to the lower end 120 of the intermediate section 108 of the shaft 102, adjacent the second bend 124 in the shaft 102. In other example aspects, the back portion 228 of the base 114 can be coupled to the upper end 148 of the lower section 106 of the shaft 102, adjacent the second bend 124. The lower section 106 of the shaft 102 can extend upwardly from its lower end 244 to its upper end 148, such that the upper end 148 of the lower section 106 can be oriented above the lower end 244 of the lower section 106, relative to the orientation shown. As such, the lower section 106 of the shaft 102 can be inclined with respect to the front and intermediate portions 226, 230 of the base 114, relative to the orientation shown. The back portion 228 of the base 114 and the lower end 120 of the intermediate section 108 of the shaft 102 can be secured together via a fastener, such as welding (not shown), or another suitable fastener known in the art. As noted above, in other aspects, the shaft 102 and the base 114 can be integrally formed with one another.

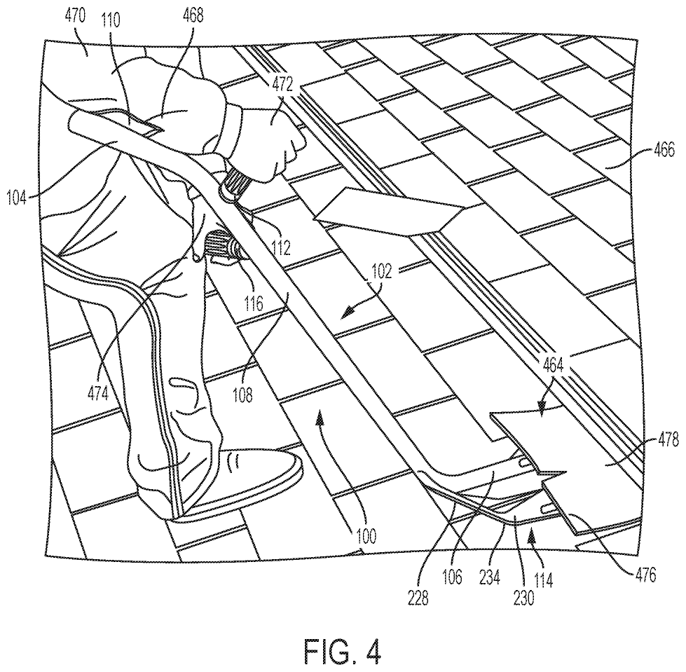

FIG. 3 illustrates the upper section 104 of the shaft 102 extending from the intermediate section 108 of the shaft 102, and further illustrates the first handle 112 and the arm rest 110 coupled to the upper section 104 of the shaft 102. As shown, the arm rest 110 can be positioned at an upper end 352 of the upper section 104. Further, the arm rest 110 can be positioned on a front side of the upper section 104, relative to the orientation shown. The arm rest 110 can define an arcuate upper surface 354 and a lower surface (not shown), and the lower surface can engage the upper section 104 of the shaft 102. The arcuate upper surface 354 of the arm rest 110 can be configured to cradle a forearm 462 of a user, as shown in FIG. 4. Example aspects of the arm rest 110 can be formed from a plastic material, such as vinyl, or a rubber material. Other example aspects of the arm rest 110 can be formed from another suitable material, or a combination of materials, that are known in the art, including but not limited to metal, resin, synthetic materials, and fibers. Some example aspects of the arm rest 110 can be formed from the same material as the shaft 102, and other example aspects of the arm rest 110 can be formed from a different material than the shaft 102.

The first handle 112 can extend from the lower end 156 of the upper section 104 of the shaft 102, adjacent the first bend 122 in the shaft 102. Like the arm rest 110, the first handle 112 can be positioned on the front side of the upper section 104 and can extend forward therefrom, relative to the orientation shown. The first handle 112 can be oriented at an angle D relative to the upper section 104 of the shaft 102. According to an example aspect, the first handle 112 can intersect the upper section 104 of the shaft 102 at approximately a 90° angle, such that the first handle 112 can extend in a direction generally perpendicular to the direction of the upper section 104 of the shaft 102. The first handle 112 can define a generally cylindrical shape defining a generally circular cross-section, with an end of the first handle 112 coupled to the upper section 104 of the shaft 102. According to example aspects, the first handle 112 can be generally sized and shaped to be grasped by a first hand 472 (shown in FIG. 4) of an adult user.

The example first handle 112 illustrated in FIG. 3 can comprise a core (not shown) encircled by a grip 360. In example embodiments, the core can be formed from the same material as the shaft 102, such as steel, and can be integrally formed with the shaft 102 or can be attached to the shaft 102 via a fastener, such as welding (not shown) or another suitable fastener known in the art. In other aspects, the core can be formed from a different material than the shaft 102. Optionally, the core can be hollow to reduce the weight and materials cost of the roofing removal tool 100, though in other aspects, the core can be solid. According to example aspects, the grip 360 encircling the core can be formed from a material that is different from the material of the core, such as, for example, vinyl, rubber, or another plastic material. However, other aspects of the core and/or the grip 360 can be formed from another suitable material, or a combination of materials, including, for example, metals, resin, synthetic materials, and fibers. Further, example aspects of the grip 360 can define a non-smooth surface. For example, the grip 360 can comprise raised areas 362 thereon that can be configured to engage the first hand 472 of the user to aid in preventing slipping of the user's first hand 472 with respect to the first handle 112.

As shown in FIG. 3, some example aspects of the roofing removal tool 100 can further comprise the second handle 116 extending from the upper end 118 of the intermediate section 108 of the shaft 102, adjacent the first bend 122 in the shaft 102. In other example aspects, the second handle 116 can extend from the upper section 104 of the shaft 102, and optionally, can extend from the lower end 156 of the upper section 104. The second handle 116 can be formed substantially similarly to the first handle 112, and can be configured to be grasped by a second hand 474 (shown in FIG. 4) of the user. The second handle 116 can be positioned on a first side of the intermediate section 108 of the shaft 102 and can extend in a sideways direction therefrom, relative to the orientation shown. The sideways direction can be a left or a right direction relative to the orientation shown and relative to the front side of the shaft 102. The second handle 116 can be spaced from the first handle 112 along the shaft 102, but can be positioned proximate to the first handle 112, as shown, such that a user does not need to bend forward to grasp the second handle 116. The second handle 116 can be oriented at an angle E relative to the intermediate section 108 of the shaft 102. According to example aspects, the angle E can be approximately 90°. As such, example aspects of the second handle 116 can extend a direction generally perpendicular to the direction of the intermediate section 108 of the shaft 102. Moreover, the first handle 112 and second handle 116 can extend in directions generally perpendicular to one another. In other example aspects, however, the first handle 112 and the second handle 116 can extend in directions that are not perpendicular to one another.

FIG. 4 illustrates an example method of using the roofing removal tool 100. As shown, the roofing removal tool 100 can be used to remove roofing materials, such as shingles 464, from a roof 466. A user can rest a forearm 468 of a first arm 470 in the arm rest 110 located on the upper section 104 of the shaft 102. The first hand 472 of the user's first arm 470 can engage the first handle 112 extending from the upper section 104 of the shaft 102. The arm rest 110 and the first handle 112 can be aligned along the front side of the upper section 104 of the shaft 102, such that a user can easily engage the arm rest 110 and the first handle 112 with the forearm 468 and the first hand 472, respectively, of the same first arm 470. Further, as shown, the upper section 104 of the shaft 102 can be angled toward the user, with respect to the intermediate section 108 of the shaft 102, to facilitate the user engaging the arm rest 110 and the first handle 112. The second handle 116 extending from the intermediate section 108 of the shaft 102 can be engaged by a second hand 474 of a user to help guide the movement of the roofing removal tool 100. The positioning of the second handle 116 proximate to the first handle 112 allows a user to grasp the roofing removal tool 100 with both hands 472,474 while maintaining a straight back and without bending forward.

As shown in FIG. 4, the first hand 472 gripping the first handle 112 can be the user's right hand, and the second hand 474 gripping the second handle 116 can be the user's left hand. In other aspects, the second handle 116 can extend from the shaft in the opposite direction to that shown in FIG. 4, and the user's left hand can thereby grip the first handle 112 and the user's right hand can grip the second handle 116.

Gripping the first and second handles 112,116, a user can push the roofing removal tool 100 forward with both hands 472,474, such that the base 114 of the roofing removal tool 100 can be wedged underneath a shingle 464 (or multiple shingles 464) on the roof 466, as shown. As the base 114 is wedged underneath the shingle 464, the inclined lower section 106 of the shaft 102 can force a front end 476 of the shingle 464 upward and away from the roof 466. To lift a rear end 478 of the shingle 464 upward, and thus detach the shingle 464 from the roof 466 completely, the upper section 104 of the shaft 102 can be pushed downward by the user pushing downward on the first handle 112 and/or the second handle 116. In other example methods of use, the user can push downwardly against the arm rest 110 instead of, or at the same time as, pushing downwardly on the first and/or second handles 112,116. A user can push downwardly on the first handle 112 and/or second handle 116 by extending their first arm 470 and/or second arm (not shown), respectively, while maintaining a generally straight back and without leaning forwards. In other example aspects, a user can squat or lunge downward to push the first and/or second handles 112,116 downward, while maintaining a generally straight back and without leaning forwards.

As the upper section 104 of the shaft 102 moves downward, the corner 234 formed between the back portion 228 and intermediate portion 230 of the base 114 can engage and pivot on the roof 466. The back portion 228 of the base 114 can pivot downward towards the roof 466, and the front portion 226 (shown in FIG. 2) and the intermediate portion 230 of the base 114 can pivot upward away from the roof 466. The teeth 240 (shown in FIG. 2) extending from the front portion 226 of the base 114 can engage and lift up the rear end 478 of the shingle 464 as the front portion 226 of the base pivots upward, thus detaching the shingle 464 from the roof 466. The teeth 240 can also engage and pull up any nails attaching the shingle 464 to the roof 466. This method can be repeated to remove additional shingles 464, as desired. The position of the handles 112,116 and shape of the shaft 102 can thereby increase the user's leverage and allow for a more comfortable working posture to make shingle removal quicker and easier.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A roofing removal tool comprising:
a shaft defining an upper section, a lower section, and an intermediate section therebetween;
a base positioned at the lower section;
a first handle extending from the upper section in a first direction; and
a second handle extending from one of the upper section and the intermediate section in a second direction that is different from the first direction.

2. The roofing removal tool of claim 1, further comprising an arm rest.

3. The roofing removal tool of claim 2, wherein the first handle is positioned between the arm rest and the second handle along the shaft.

4. The roofing removal tool of claim 1, wherein the upper section defines an upper end of the shaft and the lower section defines a lower end of the shaft.

5. The roofing removal tool of claim 4, wherein the first handle is located a first distance from the upper end of the shaft, and the second handle is located a second distance from the upper end of the shaft, and wherein the first distance is less than the second distance.

6. The roofing removal tool of claim 1, further comprising a plurality of teeth extending from the base

7. The roofing removal tool of claim 6, wherein each of the plurality of teeth are triangular.

8. The roofing removal tool of claim 6, wherein a vertex of each of the plurality of teeth is distally located from the base.

9. The roofing removal tool of claim 1, wherein the first handle is oriented generally perpendicular to the upper section.

10. The roofing removal tool of claim 1, wherein the first handle and the second handle are oriented generally perpendicular to one another.

11. The roofing removal tool of claim 1, the upper section being oriented at a first angle relative to the intermediate section and the lower section being oriented at a second angle relative to the intermediate section.

12. A roofing removal tool comprising:
a shaft defining a first end and a second end;
an arm rest coupled to the shaft at a first location along the shaft proximate to the first end;
a first handle extending from the shaft at a second location along the shaft;
a second handle extending from shaft at a third location along the shaft, wherein the second location is oriented between the first location and the third location; and
a base coupled to the shaft at a fourth location along the shaft proximate to the second end.

13. The roofing removal tool of claim 12, wherein the arm rest comprises an arcuate upper surface and a lower surface opposite the arcuate upper surface.

14. The roofing removal tool of claim 12, wherein the first handle comprises a core and a grip encircling the core, wherein the grip comprises plastic or rubber.

15. The roofing removal tool of claim 12, wherein the base comprises a plurality of teeth extending therefrom.

16. The roofing removal tool of claim 12, wherein the base comprises a first section and a second section oriented at an angle with respect to the first section to define a corner of the base.

17. The roofing removal tool of claim 16, wherein a rib is formed at the corner of the base.

18. A method for using a roofing removal tool comprising:
grasping a first handle extending from a shaft with a first hand;
grasping a second handle extending from the shaft with a second hand;
engaging a roofing material with a base extending from the shaft; and
detaching the roofing material from a roof.

19. The method of claim 18, wherein engaging a roofing material with a base extending from the shaft comprises wedging a portion of the base between the roofing material and the roof.

20. The method of claim 18, wherein detaching the roofing material from a roof comprises impelling the first handle in a first direction with the first hand and impelling the roofing material in a second direction with the base.
